(19) United States
(12) Patent Application Publication
(10) Pub. No.: US 2015/0266135 A1
(43) Pub. Date: Sep. 24, 2015

(54) Automated Vessel Manufacturing Process with Damage Resistant Walls

(71) Applicant: Kevin Alexander Paul Kirchman, Bedford (GB)

(72) Inventor: Kevin Alexander Paul Kirchman, Bedford (GB)

(21) Appl. No.: 14/666,293

(22) Filed: Mar. 23, 2015

Related U.S. Application Data
(60) Provisional application No. 61/968,387, filed on Mar. 21, 2014.
(60) Provisional application No. 61/968,389, filed on Mar. 21, 2014.

(51) Int. Cl. B23K 31/02; B29C 65/78; B22D 47/00; B22D 21/00; B22D 18/06; B23K 37/04

(52) U.S. Cl. CPC B23K 31/02; B22D 18/06; B23K 37/04; B22D 47/00; B22D 21/007; B29C 65/78; B29L 2031/307

(57) ABSTRACT

The present invention provides a novel method, device design and process for manufacturing aluminium floating vessels, such as ships, floating and fixed offshore platforms and boats, as well as land-based fluid and dry goods containers, which significantly reduces the labour costs involved, improves output quality, reduces production time and improves the damage resistance of said vessels.

The method utilizes various aluminum alloys that are cast into a form which incorporates transverse frames and longitudinal members in the vessel plates. By using vacuum die casting, the hydrogen content of the produced parts can be brought to levels that make it practical to robotically weld assemble large plate areas in an automated line. By combining plates with complementary curves, enclosed spaces can be incorporated into vessel walls to improve floatation properties and damage resistance.

The method, process and devices allow flat plates, curved, developable plates, and compound plates for both spherical and other surfaces to be assembled in an automated manner.

### CROSS-REFERENCE TO RELATED APPLICATIONS

This application claims the benefit of U.S. Provisional Patent Application 61/968,387, filed on Mar. 21, 2014 and U.S. Provisional Patent Application 61/968,389, filed on Mar. 21, 2014 by the same inventor, which are incorporated by reference herein.

### FIELD OF THE INVENTION

This invention relates to the fabrication of large aluminium vessels and tanks for marine or other purposes.

### BACKGROUND OF THE INVENTION

Ship and boat construction industry has a history of thousands of years that has generally involved much manual labour to create the uneven, compound surfaces that are required of the aerodynamic/hydrodynamic hull forms. From wood, to steel, fibreglass and aluminium alloys, large groups of people have been required to assemble large vessels from many custom-formed individual sheets that are attached to frames that must be built in a bespoke manner for each vessel. Although fiberglass boat-building methods have made mass production possible, this is for smaller boats, and not as cost effective for large ships or offshore structures.

Although there have been innovations in shipbuilding such as the Sandwich Plate System (SPS) that improves the strength of hull and deck forms, and reduces their weight, these methods do not incorporate the automation that eliminates much of the manual forming and cutting normally required for ship and tank building.

### PRIOR ART

The prior art includes patents on boat fabrication technologies, one of which is:

In A. Kazunari, S. Nobuo; Y. Shingo, I. Hiroshi, and U Norimasa in JP7125681, the inventors disclose an aluminium boat fabrication technology for honeycomb panels connection, but this is not competitive with the present invention.

### BRIEF SUMMARY OF THE INVENTION

The present invention provides the process, method and devices by which the automated production of large vessels, walls and tanks can be accomplished, providing a practical means by which the labour costs of the shipbuilding, tank and wall construction enterprises can be significantly reduced, thus ultimately reducing overall costs and production time and improving manufacturing tolerances.

The invention includes a novel use of the new technology to make a hull or wall form that is significantly more resistant to damage and incorporates watertight pockets that also improve a vessel's buoyancy when damaged. Such a hull form is also substantially stiffer than other methods of hull or vessel construction.

One aspect of an embodiment of the present invention is to provide a process and method whereby aluminium in ingot form enters an assembly line, is converted to molten form, forced into a vacuum casting machine, exits the machine to a heat treatment oven, proceeds to a robotic assembly line where it is then placed at high temperature in proximity to other, similar parts, and robotically welded to form a large vessel wall, with minimal involvement of manual labour.

A second aspect of an embodiment of the present invention is to provide an aluminum-alloy, die-cast-able vessel wall piece that incorporates Transverse Frames and Longitudinal Members required for structural support under the high pressure that vessels must be designed for, whether they be floating vessels or vessels holding liquids or small solid particles.

A third aspect of an embodiment of the present invention is to provide a means and device of part holding that allows automated welding on the part production line, such part holding devices being removable by mechanical impact.

A fourth aspect of an embodiment of the present invention is to provide beveled edges on a cast vessel part so that human intervention is not required prior to welding.

A fifth aspect of an embodiment of the present invention is to automatically and inexpensively form water-tight enclosures within the walls of ship vessels or tanks so that they may be more resistant to damage and sinking

The devices can be fabricated from any of the various alloys of aluminium or even of plastic, concrete or composites as is known in the art.

### DETAILED DESCRIPTION OF THE INVENTION

FIG. 1 shows a view of an aspect of the embodiment of the invention which is a curved, developable metal surface after being welded into an assembly, showing both sides. The Welds 102 have been robotically welded as per the method and process of the embodiment of the invention and are between each of the plates throughout. This assembly could then be welded to other assemblies to form a full ship, yacht, boat, building wall or storage container.

FIG. 2 shows a flat plate with frame structures cast in place. The shown plate can be welded on all four sides to a connecting plate after produced by a vacuum-casting process. Notice also the filets on the ribs. All kinds of features that normally are incorporated with human involvement in the ship-building current art can be cast in place with this aspect of the embodiment of the invention.

FIG. 3 shows a curved, developable plate. Notice again the protruding incorporated ribs or frame structure. This plate also can be welded on all four sides to a connecting plate after produced by a vacuum-casting process.

FIG. 4 shows a spherical, compound plate with frame structures cast in place, which can also be welded after being produced by a vacuum-casting process which removes hydrogen-based porosity.

FIG. 5 shows a compound plate of the more general case that also can be welded after vacuum casting.

FIG. 6 shows a flat surface incorporating Side Connectors 606 and having sides beveled for welding. The Side Connectors 606 used here are the post-and-slot type known in the art, but could be another type. The slots can be welded through, if they are designed thinly enough, while the posts can be broken of with a mechanical impact on the side. Both the Side Connectors 606 and the Bevels 608 are incorporated in the unit during the vacuum-casting process, and serve the purpose of alignment for automated welding processes.

FIG. 7 shows two plates, with their frame members facing each other in position ready to be moved together in order to be welded where the frames meet, thus forming an enclosure containing air, gas or a vacuum. This could be the outside of a vessel, or an inside wall or bulkhead, depending on the curvature of the hull.

FIG. 8 shows a translucent view showing the two plates together, with the enclosed, air-tight chamber that provides buoyancy in the event of a rupture due to collision, for instance.

FIG. 9 shows 21 units of the previously described panels welded together, in this translucent view, showing the reversal of curvature and the air-tight enclosures/chambers formed through the assembly. This demonstrates how with careful planning and the use of supportive jigs in robotic welding, practically any compound shape can be created automatically, incorporating as in this embodiment damage resistant walls or hull forms. The panels could alternatively be formed with ribs or frames of any design, including as necessary ports for internal piping or wiring, or for through-bilge access.

### BRIEF DESCRIPTION OF THE DRAWINGS

The invention is herein described, as through example only, with reference to the accompanying drawings, wherein:

FIG. 1 is a schematic diagram providing an overview of a boat hull assembled from the design units.

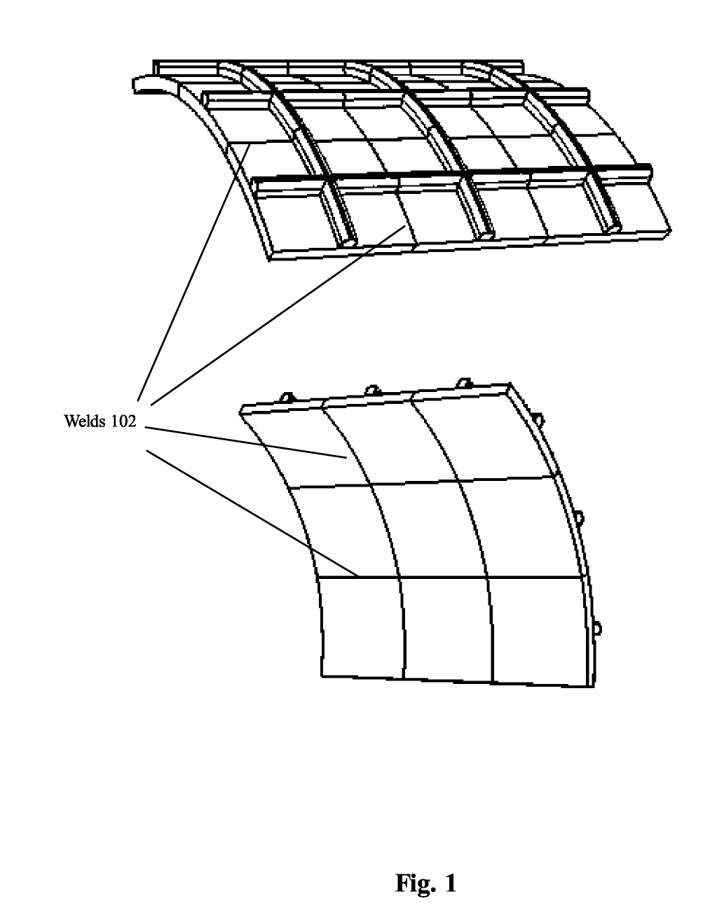

FIG. 2 is a diagram showing a Vessel Plate Part for a flat plate.

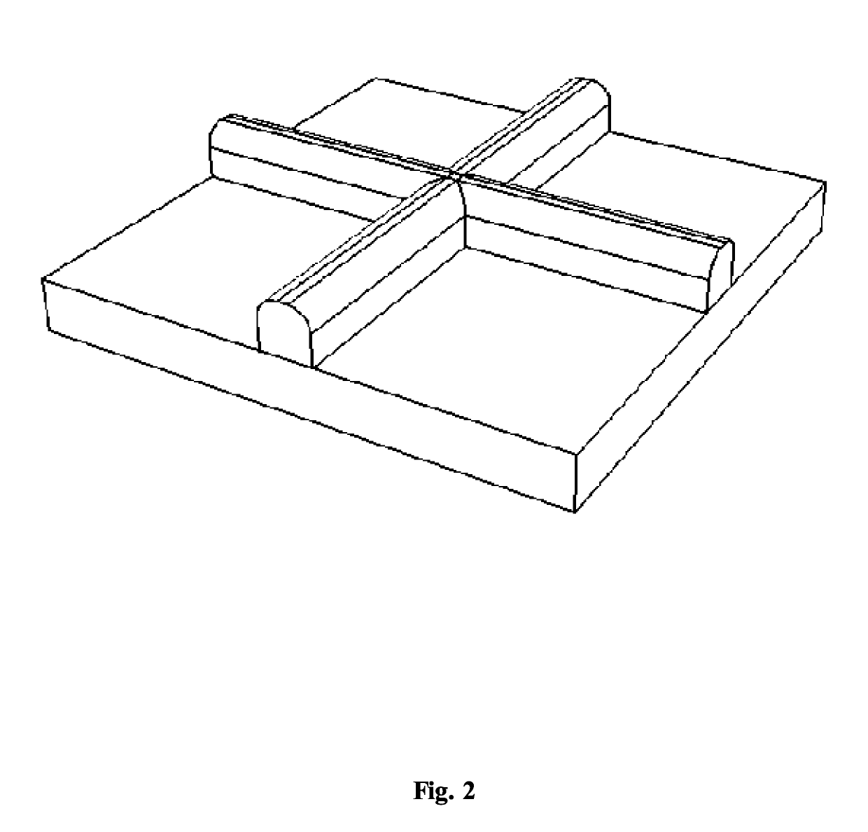

FIG. 3 is a diagram showing a Vessel Plate Part for a developable curved plate.

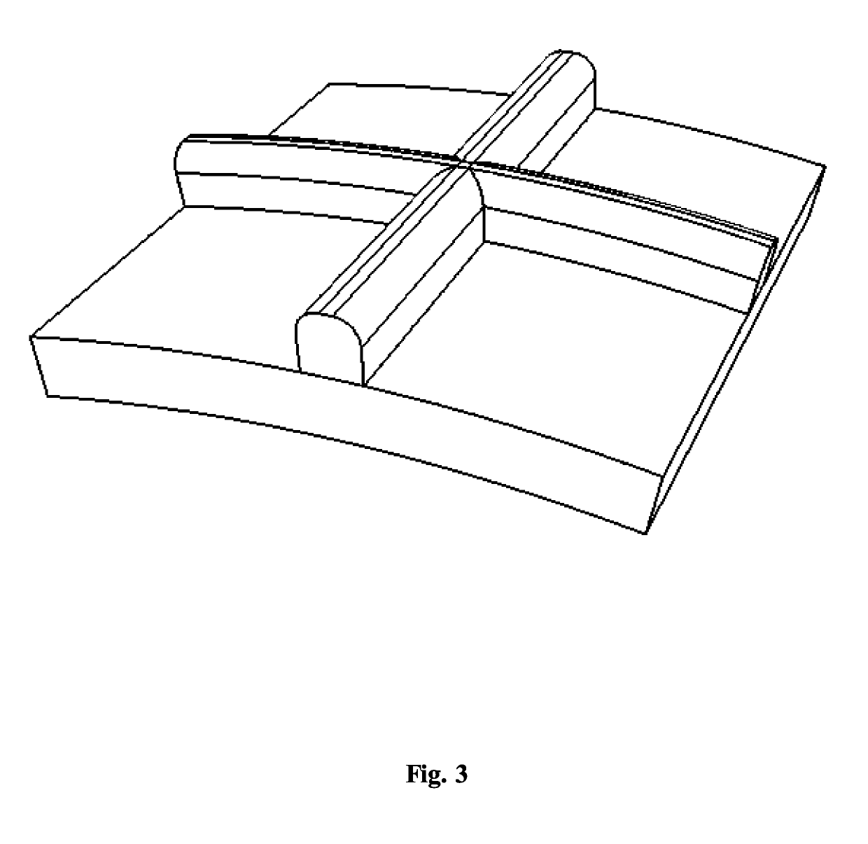

FIG. 4 is a diagram showing a Vessel Plate Part for a spherical compound plate.

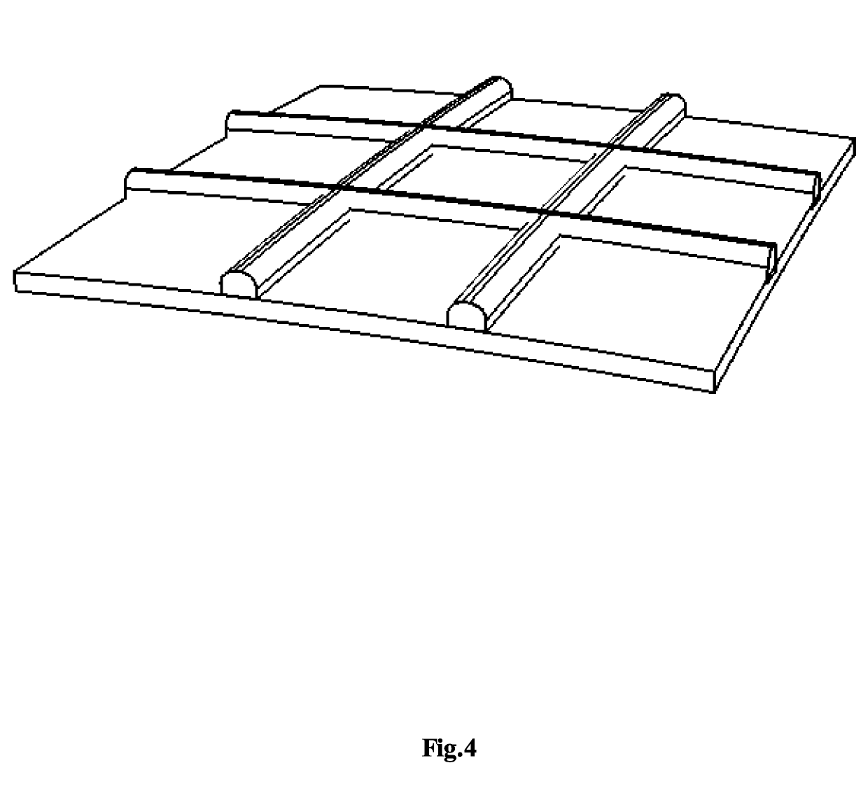

FIG. 5 is a diagram showing a Vessel Plate Part for a compound plate.

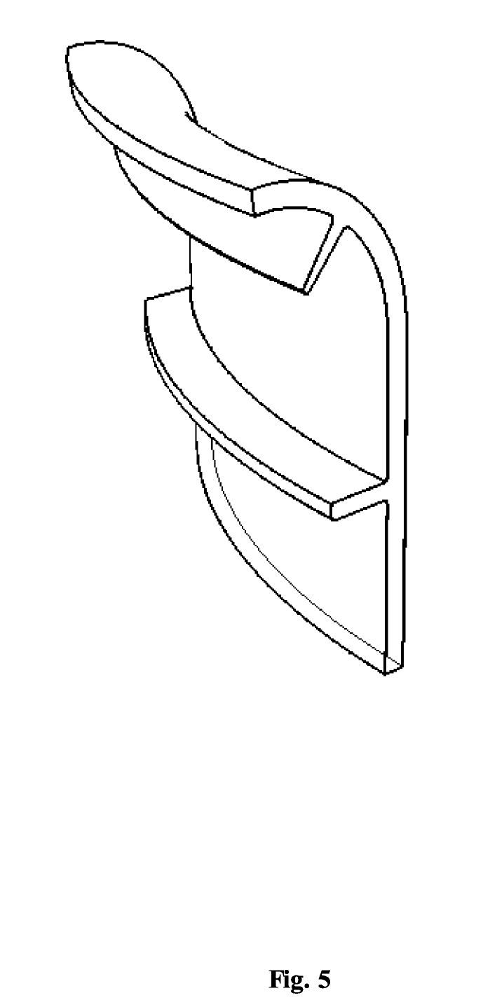

FIG. 6 is a diagram showing a Vessel Plate Part incorporating Sides Connectors and Beveled Edges.

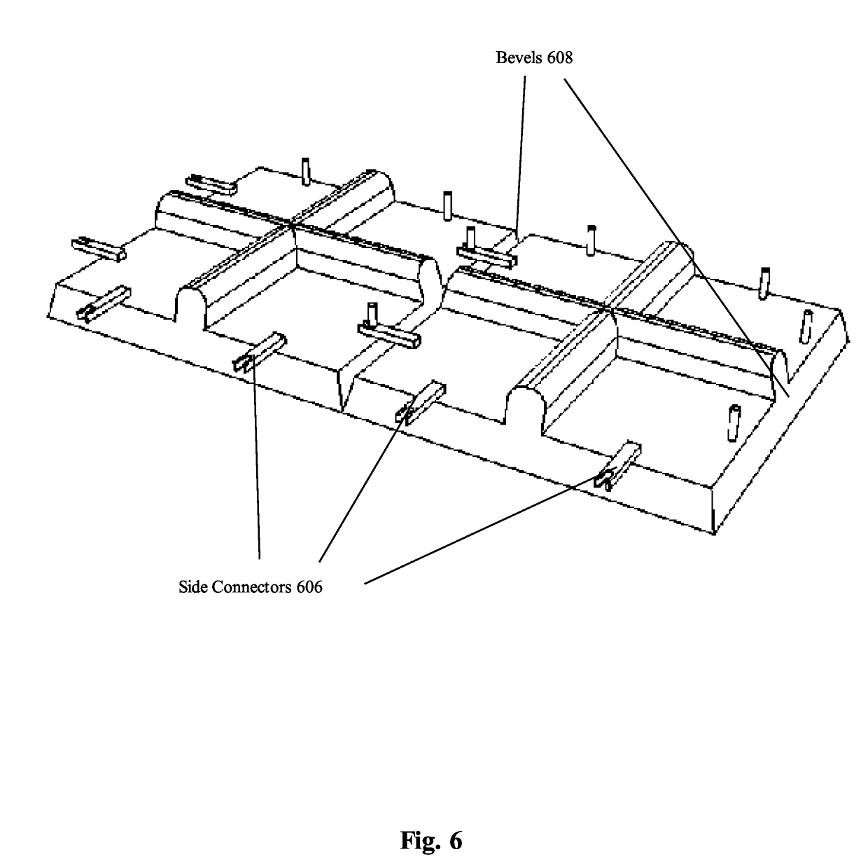

FIG. 7 is a diagram showing two Vessel plates, with their die-cast, incorporated ribs, opposing each other in position to be welded together to create an internal enclosed space for buoyancy or improved damage resistance.

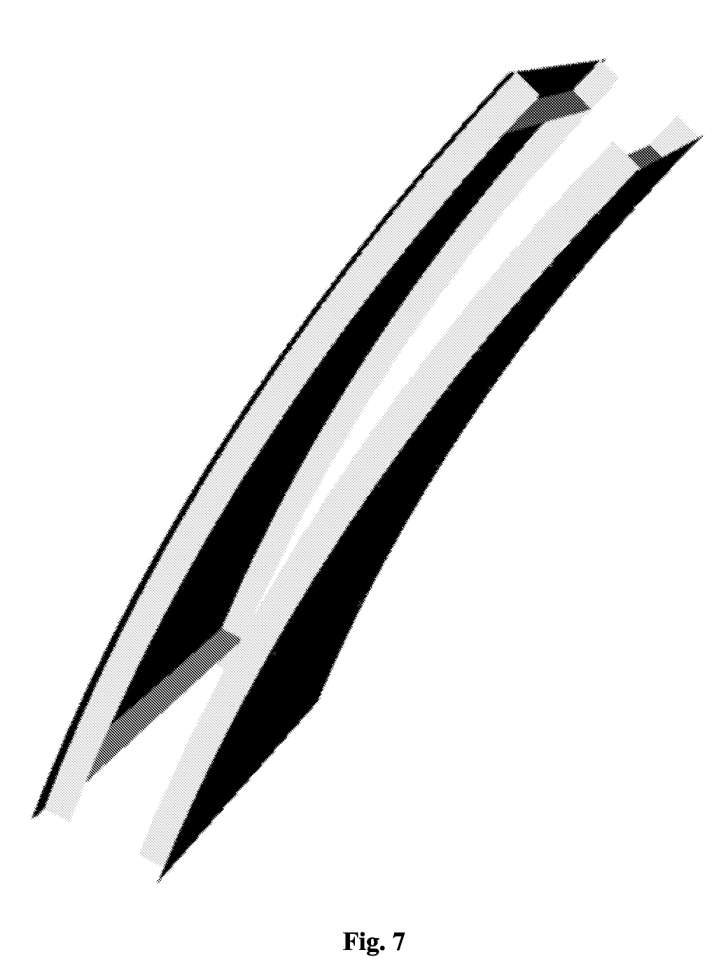

FIG. 8 is a diagram showing the two Vessel Plate Parts welded together, in a translucent view for clarity.

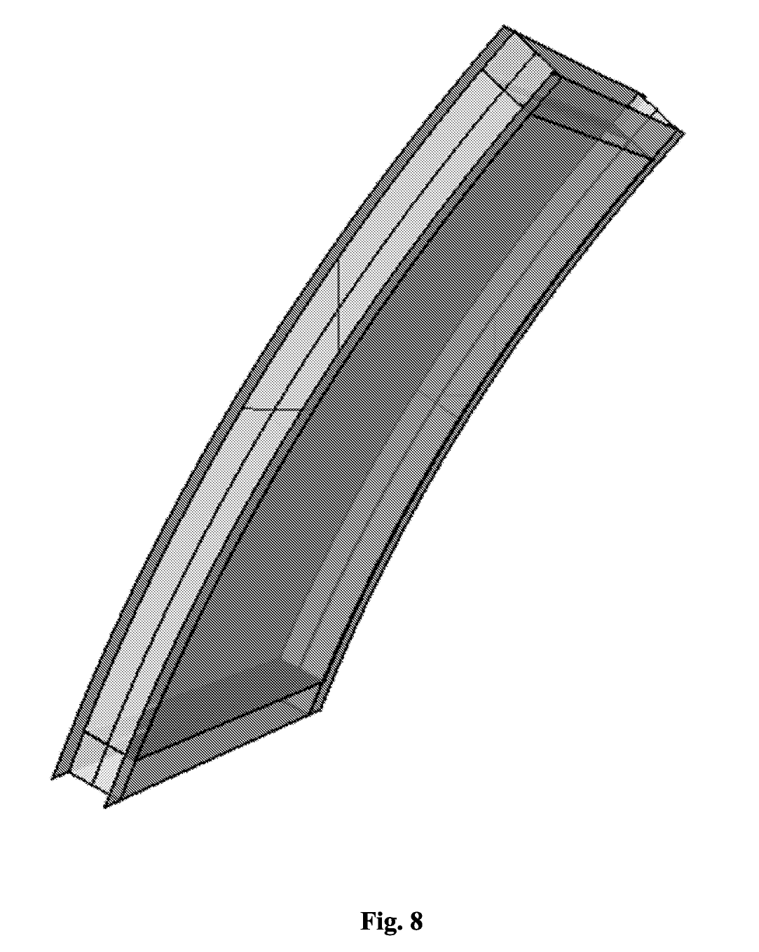

FIG. 9 is a diagram showing a multitude of Vessel Plate Parts welded together forming a vessel hull.

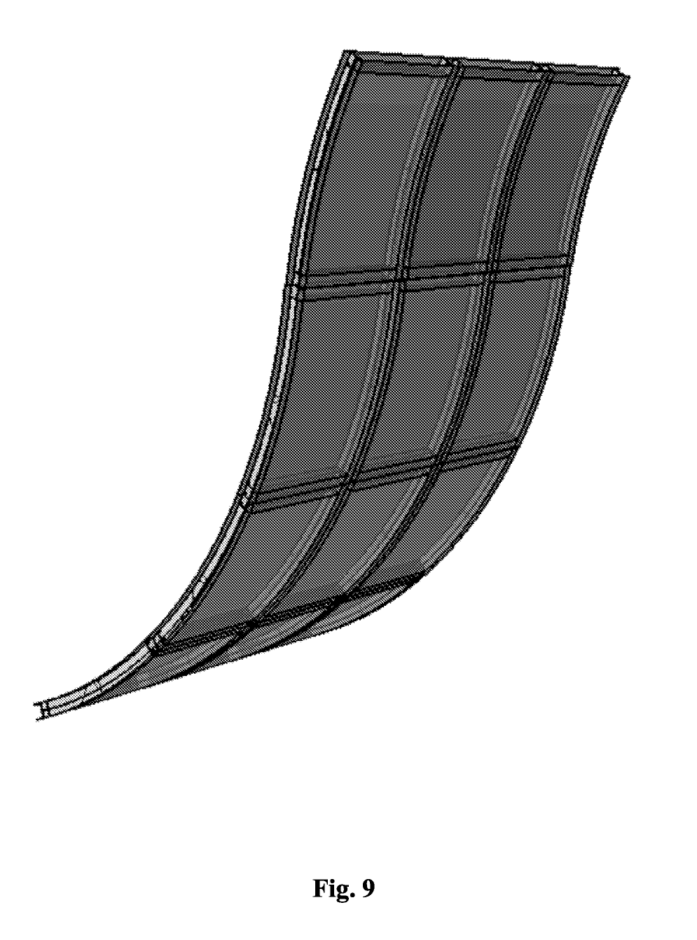

### CONCLUSIONS, RAMIFICATIONS AND SCOPE

Thus the reader can see the invention provides a means of creating shapes of metal, especially for large vessels, by casting from metal, such as aluminium alloy, magnesium or other castable metal, which can be welded by one of many welding processes, such as friction stir weld, GMAW or GTAW, as is known in the art, using robotic welding machines, affected by offline programming for instance.

These shapes and welded sections can incorporate through vacuum-casting in advance, framing of any shape or thickness, as well as features such as ribs, fillets, bevels, and holes, and be combined with one another to provide buoyancy, sound proofing or greater structural rigidity, in facing pairs or multiple-faced place of any curvature.

While the above description contains specific details, these should not be construed as limitations on the scope, but rather as an exemplification of one or several embodiments thereof. Other variations are possible.

Accordingly, the scope should be determined not be the embodiment illustrated, but by the appended claims and their legal equivalents.

What is claimed is a method of fabrication using:

1. An automated metal or metal-alloy vessel production line comprising:
A Vacuum-casting Line to produce low-hydrogen content Vessel Plate Parts including moulds for such Parts;
A number of said Vessel Plate Parts produced by said Vacuum-casting Line that incorporate Transverse Frames and Longitudinal Members in their design;
An automated robotic welding and assembly line for combining said Vessel Plate Parts into larger pieces by welding, holding said Vessel Plate Parts in proximity by jigs, other robots, or other means as is known in the art.

2. The method, process and devices of claim 1 whereby said Vessel Plate Parts are flat plates.

3. The method, process and devices of claim 1 whereby said Vessel Plate Parts are curved, developable plates.

4. The method, process and devices of claim 1 whereby said Vessel Plate Parts are compound curvature plates.

5. The method, process and devices of claim 1 whereby said Vessel Plate Parts are compound curvature plates.

6. The method, process and devices of claims 2-5 where said various Vessel Plate Parts have incorporated edges that have incorporated Sides Connectors so that they can be assembled and held easily prior to welding.

7. The method, process and devices of claims 2-6 where said Vessel Plate Parts have beveled edges incorporated in their design so that grinding is not necessary to prepare the weld surfaces prior to welding.

8. The method, process and devices of claims 2-7 used to fabricate a boat, ship, float, offshore platform, storage tank, structure wall, or wind turbine tower that incorporates said Vessel Plate Parts.

9. The method, process and devices of claims 2-8 plate material is of a plastic or fiber-composite, rather than metal, and polymer welding is used.

10. The method, process and devices of claims 2-9 where said Vessel Plate Parts are welded together along frame members so as to form an enclosure providing structural rigidity the Vessel Plate Parts.

11. The method, process and devices of claims 2-10 where said Vessel Plate Parts are welded together along frame members so as to form an enclosure by which means buoyancy of the assembled piece is greater than the mass of the Vessel Plate Parts.
